(19) United States
(12) Patent Application Publication
(10) Pub. No.: US 2026/0241795 A1
(43) Pub. Date: Aug. 20, 2026

(54) Method and Apparatus for Outputting Information to a User of a Means of Transportation

(71) Applicant: Bayerische Motoren Werke Aktiengesellschaft, Muenchen (DE)

(72) Inventors: Alexander Stuckert, Muenchen (DE); Tabea Schluerscheid, Muenchen (DE); Denise Sogemeier, Muenchen (DE)

(21) Appl. No.: 18/842,758

(22) PCT Filed: Jan. 19, 2023
(86) PCT No.: PCT/EP2023/051192

§ 371 Date: Aug. 29, 2024

(30) Foreign Application Priority Data
Mar. 18, 2022 (DE) 10 2022 106 328.3

(51) Int. Cl. B60K 35/28; B60K 35/10

(52) U.S. Cl. CPC B60K 35/28; B60K 35/10; B60K 2360/1438; B60K 2360/162; B60K 2360/1868; B60K 2360/188; B60K 2360/334

(57) ABSTRACT

A method for outputting information to a user of a means of transportation includes ascertaining information to be displayed using the means of transportation, and providing a light pattern representing the information onto a projection surface of the means of transportation. The light pattern can be provided at least by projecting the light pattern on the projection surface, outputting the light pattern using an ambient lighting unit, or a combination of both.

The present application is the U.S. national phase of PCT Application PCT/EP2023/051192 filed on Jan. 19, 2023, which claims priority of German patent application no. 10 2022 106 328.3 filed on Mar. 18, 2022, the entire contents of which are incorporated herein by reference

### TECHNICAL FIELD

The present disclosure relates generally to a device, to a means of transportation, and to a method for outputting information to a user of a means of transportation.

### BACKGROUND

The increased number of features of current means of transportation requires a large number of interactions, which a driver can perform while exercising the driving task. A current trend in vehicle interior design is to eliminate the need for individual buttons by using large-area touchscreens. Due to the increasing absence of buttons and other user interfaces designed in hardware (e.g. touchscreen, steering wheel), tactile feedback for the driver on the inputs he/she makes is no longer available.

In the prior art, decorative ambient lighting systems are used, with which the vehicle interior can be visually enhanced and optionally adapted to the mood of the occupants.

The tactile feedback is essential for detecting a successfully performed or at least triggered function. A lack of feedback while driving can lead to uncertainty for the driver and thus create a potential source of distraction for the driver in the exercise of the driving task. For example, the driver may want to verify the functionality of the system due to a lack of feedback, thereby distracting the driver from the performance of the driving task.

### SUMMARY

At least some embodiments disclosed herein provide an alternative output of information to the user that reduces distractions to the user from performing the driving task and can take place alternatively or in addition to the output of tactile feedback.

At least some embodiments disclosed herein provide visual feedback, in particular, in the absence of tactile feedback. In order to avoid formulating/placing expected feedback messages too intrusively, feedback on a successfully triggered function can be provided in a very subtle form. In the case of visual feedback, it can be output in the secondary field of view of the user. One form of visual feedback can be a projection onto a surface in the (secondary) field of view of the user or next to the control panel, or alternatively, the visual feedback can be realized by an illuminated surface, in particular an indirectly illuminated surface. An illuminated surface or illuminated element in the secondary field of view of the user serves as visual feedback in response to a user action, in particular a voice input, or the actuation of a button by the user. The surface can be statically or dynamically illuminated and provide meaningful feedback in response to the user's voice commands. For example, by means of a projector (comprising a screen or a digital image panel), a symbol, a shape or a color, in particular also a piece of text, can be projected onto a surface in the secondary field of view of the user. A secondary field of view is another term for the peripheral field of view, which is located away from the central field of view or the primary field of view of the user, i.e. their main direction of view. This means that the driver will not experience excessive distraction, in particular in the event that the function was successfully triggered or even successfully executed.

According to a first aspect, a method for outputting information to a user of a means of transportation is proposed. The method can be carried out on board the means of transportation, which can be in the form of a passenger car, minivan, motorcycle, truck, aircraft and/or watercraft. The user can be understood as the driver of the means of transportation. First, information is ascertained which is to be presented to the user by the means of transportation. For example, this can be a feedback message about a successful triggering of a function, or at least an acknowledgment of a successful user input. Then a light pattern representing the information is projected onto a dashboard of the means of transportation. The projection surface is a passive surface, which can be clad in particular with a plastic material, leather, wood or the like. In particular, it is not a monitor or a similar display device for providing an optional layout of display contents. Alternatively or additionally, an ambient lighting unit can also be used, which in particular allows indirect illumination of an interior of the means of transportation. Via the ambient lighting unit, the dashboard of the means of transportation can also be (indirectly) provided with an illuminated pattern, so that the surface of the trim of the dashboard is illuminated in the ambient light, reflecting the information to be output in the form of the light pattern. In particular, the ambient light is not viewed by the user directly or through a diffuser, but only generates ambient light reflected at passive surface regions, detectable by the user as the information. By generating the light pattern in a secondary or peripheral field of view of the user, it is possible to avoid distracting the user too strongly from the driving task by the output of the light pattern. Instead, the information or the light pattern preferably communicates an “OK” signal as acknowledgment of a user input or of a function triggered by the user. For less important information, the user is less strongly distracted from the vehicle driving task by the light pattern generated than is customary in the prior art. Nevertheless, the driver has the certainty that any input or desired function call he/she makes has been recognized by the means of transportation and on account of this information can then devote him/herself completely to the driving task again.

Several advantageous embodiments are contemplated.

For example, the information can represent an operating state of a speech dialog system. For example, the speech dialog system can use a first color to represent a standby mode, a second color to represent an active listening mode started after recognition of a keyword or after a predefined user input, a third color to represent a processing of the received speech input and a fourth color to represent an execution of a function invoked by the speech input. Similar color schemes are known from so-called smart speakers or home speakers. Alternatively or in addition, the information can also represent an output of the speech dialog system or the output of the invoked function itself. In other words, the light pattern itself can carry information through which the user can satisfy the communicated request for knowledge.

For this purpose, the light pattern can represent, for example, an arrival time, the name of a road currently being used, a weather condition, a distance to the execution of a next maneuver on a guided route or similar. This information can also be output by means of an icon, a symbol, a color, or alphanumeric characters.

A position of the projection or the output of the light pattern can be automatically varied, in particular depending on an operating state of the means of transportation. For example, during a manual driving mode, the light pattern may be further away from the user's primary field of view than in an automatic or highly supported driving mode. In particular, in the case of an automated driving mode or a highly supported driving mode, the information can be output by a light pattern located in the user's primary field of view, while the light pattern is otherwise generated in the secondary or peripheral field of view of the user (driver).

For example, the information or the light pattern can represent a text output of a speech dialog system, and alternatively or additionally an operating state change of a driver assistance system and/or feedback in response to a user input, in particular by means of a touchscreen. In particular, the operating state change of a driver assistance system can also represent a take-over request, which prompts the user to take control of the driving task. The light pattern may also contain a combination of alphanumeric characters, symbols, and colored shapes. The design can be based on the information to be output or the combination of information to be output.

In particular, in response to an input by the user the information can be represented by means of a multifunction steering wheel. Modern multifunction steering wheels have touch-sensitive surfaces and/or continuous rotating rollers or similar, so that the user can perform the inputs while keeping their view directed at the vehicle surroundings. In particular in the case that an effect of the input cannot be evaluated immediately or directly by the user (for example, is the set audio volume sufficient if an audio signal is present again?), then the light pattern can represent a discreet yet important indication of the user input and avoid imprecise input or undesirable consequences of input.

A concrete example of information which can be communicated is a target temperature, which can be represented by a blue or red light within the light pattern. If, for example, the target temperature is changed by a voice command of the occupant, a blue light pattern can be generated when the setpoint temperature is lowered, and a red light pattern (at least temporarily) when the setpoint temperature is raised in order to acknowledge the input.

The information can represent a current or upcoming weather situation at a location requested by the user or predefined. The light pattern can comprise a pictogram and/or a symbolic animation, depending on the weather condition. For example, snowflakes, rays of sunshine, clouds or blowing leaves (symbolizing strong wind) can be generated in the user's peripheral field of view to represent a content-based response to the user's request.

In particular, an expected arrival time can also be represented by the information. The arrival time may vary, in particular as the journey proceeds. In order to adapt the vehicle guidance to the expected arrival time, the information for the user on whether a desired arrival time (target arrival time) is expected to be comfortably achievable (green), only slightly missed (yellow) or not realistic (red). Accordingly, the coloring of the light pattern in the peripheral field of view of the user can provide a continuous orientation as to whether the user will arrive punctually, in good time or late. Thus, without the interpretation of alphanumeric characters, the user can make an adjustment to the longitudinal guidance of the means of transportation or an adjustment to the route, without being excessively and unreasonably distracted from the vehicle guidance task.

According to a second aspect, a device for a means of transportation is proposed, which is capable of carrying out the method described above. For this purpose, the device has a dashboard with a projection surface onto which a light pattern can be projected. An evaluation unit with a data input and a data output is configured to record or generate the information and output it via the data output to the projector or the ambient lighting unit. The projector or ambient lighting unit then displays the light patterns described above on the dashboard projection surface. Thus, the device can be used to realize the features, feature combinations and the advantages of one or more of the methods discussed above.

Preferably, the device may also have a fitting protruding from the dashboard, so that behind the dashboard a shaded area is produced from the point of view of the user (driver and/or front passenger). On the rear of the fitting, the projector and/or the ambient lighting unit can be arranged, which are used to generate the light pattern. By placing the projector or ambient lighting unit such that it is hidden from the user, the result is a particularly neat exterior and a high-quality overall impression of the vehicle interior.

In particular if a continuous input means (scroll wheel or slider) is used, the light pattern can represent a position of the input means. In this way, a focal point in the light pattern or a point of highest intensity or of a different color to other areas of the light pattern can represent the position of the input means (finger, cursor, etc.). In the peripheral field of view of the user, information can thus be output about which region of the continuous scale has currently been reached. This visualization of the position of the input means can alternatively or additionally also be represented by a color pattern of the light pattern, wherein high values are marked red, medium values yellow and low values green or blue (depending on the selected physical variable). The color gradient can also be matched essentially continuously to the controlled variable or the current position of the input means.

According to a third aspect, a means of transportation is proposed, which can be in the form of, for example, a passenger car, minivan, motorcycle, lorry, aircraft and/or watercraft. The device of the means of transportation is designed according to the second aspect, so that with regard to the features, combinations of features and the advantages resulting from them, reference can be made to the above comments. Of course, the projector or the ambient lighting unit can also be arranged on a functional center, a roof, behind an interior mirror, a sun visor or in the A-pillars of the means of transportation in order to generate the light patterns and at the same time allow a tidy vehicle interior.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a schematic representation of an exemplary driver's workstation of a means of transportation, on which the position of the fields of view “primary field of view” and “peripheral field of view” or “field of view” are visually highlighted;

FIG. 2 shows a perspective representation of a driver's workstation of a means of transportation according to FIG. 1 having an exemplary embodiment of a device for outputting information;

FIG. 3 shows 10 schematic representation of the driver's workstation shown FIG. 1 with second exemplary embodiment of a device for outputting information comprising a projector;

FIG. 4 shows a schematic representation of the driver's workstation shown in FIG. 1 with a third exemplary embodiment of a device for outputting information comprising a projector;

FIG. 5 shows a schematic representation of a dashboard comprising an exemplary embodiment of a device for outputting information; and

FIG. 6 shows a flow chart illustrating steps of an exemplary embodiment of a method for outputting information to a user of a means of transportation.

### DETAILED DESCRIPTION

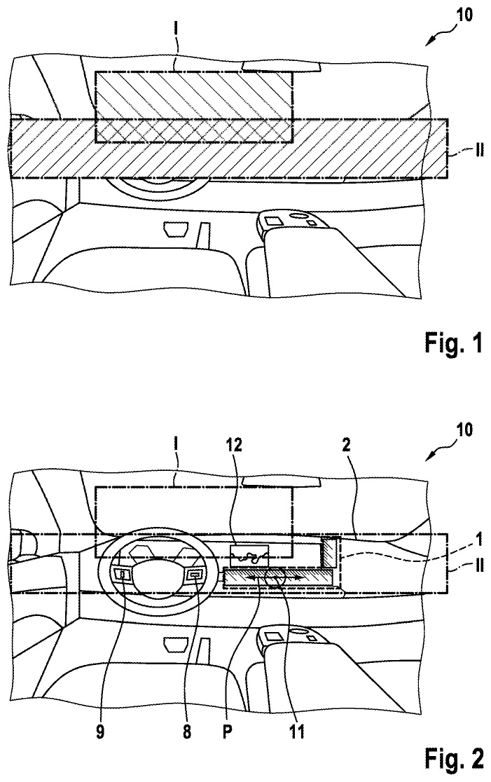

FIG. 1 shows a driver's workstation of an exemplary embodiment of a means of transportation 10, on which the primary field of view I of the user and the peripheral field of view II of the user are optically highlighted. The primary field of view I of the user extends on the left edge up to the A-pillar, on the right edge a few centimeters beyond the center of the vehicle, at the top edge approximately to the bottom edge of the interior mirror and at the bottom edge approximately to the center of the instrument cluster and the central information screen. The secondary field of view II extends approximately from the left-hand door mirror the right-hand door mirror, approximately to the windshield base at the upper edge, and approximately to the lower edge of the steering wheel impact absorber at the lower edge.

FIG. 2 shows the driver's workstation already shown in FIG. 1, in the dashboard 2 of which a touchscreen 12 is inlaid as a central information display. The touchscreen 12 is located in the driver's primary field of view I. The fitting, within which the touchscreen 12 is located, is configured to output a light pattern 1 indirectly reflecting on the dashboard 2, via which information directed to the user can be visualized. For example, the user has the option of changing continuous values via a slider 8 and a rotary control 9 in the multifunction steering wheel, which would not be directly detectable, for example, by feedback from the means of transportation. For example, an audio volume can only be evaluated by the user if an audio signal known to the user is currently being played back. The same applies to an inert heating device (seat heater, window heater, etc.). Therefore, a focal point 11 of the light pattern 1 is varied to the left or to the right in the direction of a double arrow P in order to provide an orientation in the peripheral field of view II of the user about the current target temperature of a seat heater.

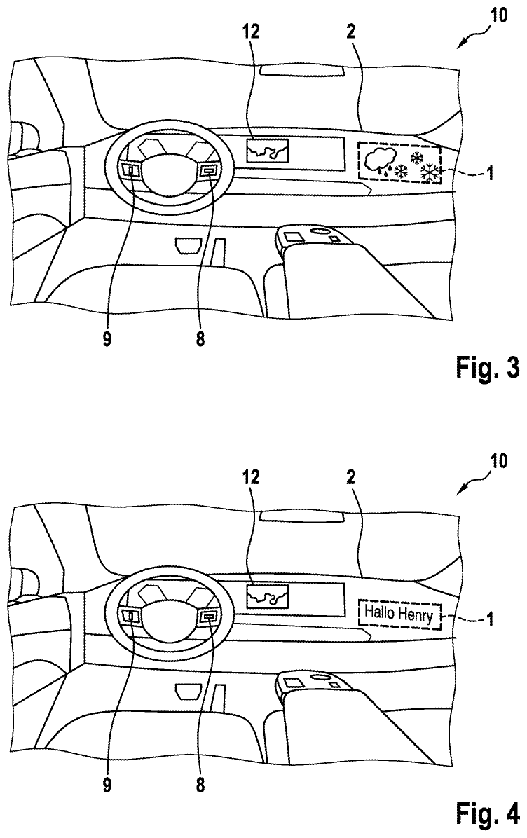

FIG. 3 shows the driver's workstation of the means of transportation 10 already presented in FIG. 2, in which now a projector (not shown) behind the fittings or behind the touchscreen 12 is used to project a light pattern 1 comprising weather symbols onto the dashboard 2. This display can be the result of a request from the user about the weather forecast at the destination. The light pattern 1 is also located in the user's peripheral field of view.

FIG. 4 shows the driver's workstation already presented in FIGS. 1, 2 and 3, in which a projector (not shown) behind the touchscreen 12 can be used to project alphanumeric characters as a light pattern 1 onto a dashboard 2 of the means of transportation 10. Since the outputs are also in audible form, the projection is only a redundant piece of information, which is well positioned in the peripheral field of view of the user, so as not to overload the driver's attention. However, depending on the vehicle driving condition, the user can briefly turn their gaze onto the dashboard 2 in the event of acoustic comprehension difficulties, in order to perceive the “Hello Henry” output of the means of transportation in text form.

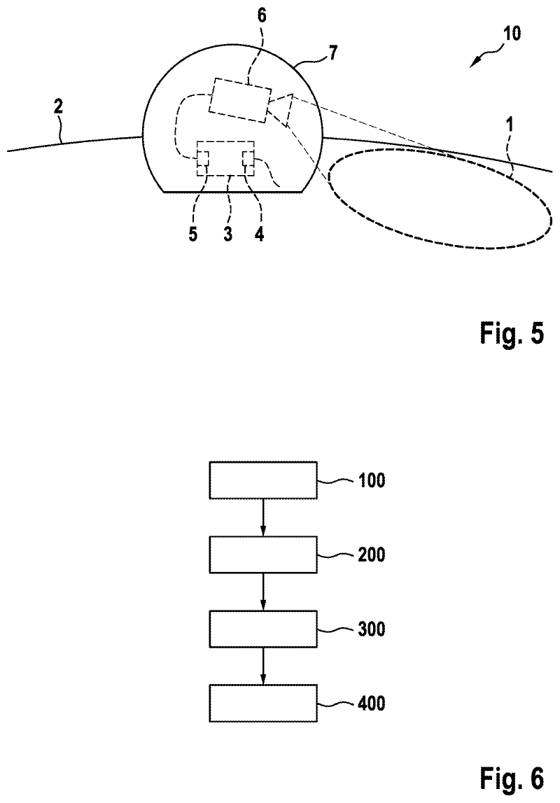

FIG. 5 shows a further exemplary embodiment of a device for outputting information, in which a tachometer is provided centrally on a dashboard 2 as a substantially free-standing fitting 7. Dashed lines indicate a projector 6 and an evaluation unit 3 with a data input 4 and a data output 5 located on the rear side, i.e. facing the windscreen. The projector 6 is configured to project a light pattern 1 onto the dashboard 2, which is structured according to information received via the data input 4. The light pattern 1 can visually enhance the interior or illustrate feedback messages regarding user input. In addition, route- or vehicle-related information can also be communicated by the light pattern 1 without any specific user request.

FIG. 6 shows steps of an exemplary embodiment of a method for outputting information to a user of a means of transportation. In step 100, an information item to be displayed is ascertained by means of the transportation means. This can be carried out, for example, via a bus system and/or by means of a control unit of the means of transportation. Step 200 categorizes the information to be displayed and uses a color associated with the category and a graphic associated with the category for the light pattern. Then, in step 300, a light pattern representing the information is projected onto a dashboard of the means of transportation and simultaneously in step 400, a light pattern representing the information is output by means of an ambient lighting unit as indirect illumination on the dashboard of the means of transportation. This takes place in the peripheral field of view of the user (the driver), so that the driver is distracted from performing the vehicle driving task as little as possible.

### LIST OF REFERENCE SIGNS

1 light pattern
2 dashboard/instrument panel
3 electronic control unit
4 data input
5 data output
6 projector
7 fitting
8 slider
9 rotary control
10 passenger car
11 focal point of the light pattern
12 touchscreen
100 to 400 method steps
I primary field of view
II peripheral field of view
P double arrow

1-12. (canceled)

13. A method for outputting information to a user of a means of transportation, comprising:
ascertaining information to be displayed using the means of transportation,
providing a light pattern representing the information onto a projection surface of the means of transportation using at least one of the group consisting of:
projecting the light pattern on the projection surface; and
outputting the light pattern using an ambient lighting unit.

14. The method as claimed in claim 13, wherein providing the light pattern representing the information on the projection surface further comprises projecting the light pattern on the projection surface, wherein the projection surfaces forms at least a portion of a dashboard of the means of transportation.

15. The method as claimed in claim 13, wherein providing the light pattern representing the information on the projection surface further comprises outputting the light pattern on the projection surface, wherein the projection surfaces forms at least a portion of a dashboard of the means of transportation.

16. The method as claimed in claim 13, wherein the information represents an operating state of a speech dialog system.

17. The method as claimed in claim 16, wherein the information represents an operating state of an output of the speech dialog system to a user.

18. The method as claimed in claim 13, wherein the information represents a text output of a speech dialog system

19. The method as claimed in claim 13, wherein the information represents a change of operating state of a driver assistance system.

20. The method as claimed in claim 13, wherein the information represents a feedback in response to a user input using a touchscreen.

21. The method as claimed in claim 13, further comprising:
categorizing the information to be displayed and using for the light pattern at least one of the group consisting of:
a color assigned to the category; and
a graphic assigned to the category.

22. The method as claimed in claim 13, wherein
the information represents a target temperature; and
the light pattern comprises a hue from a plurality of hues selected depending on the target temperature.

23. The method as claimed in claim 13, wherein:
the information represents a weather condition; and
the light pattern comprises a pictogram selected from a plurality of pictograms depending on the weather condition.

24. The method as claimed in claim 13, wherein:
the information represents a weather condition; and
the light pattern comprises a symbolic animation selected from a plurality of symbolic animations depending on the weather condition.

25. The method as claimed in claim 13, wherein
the information represents an expected arrival time and
the light pattern represents information representative of an expected punctual arrival, an expected slight delay, or an expected significant delay, depending on the expected arrival time and a predefined target arrival time.

26. A device for a means of transportation, comprising
a dashboard,
a data input,
an evaluation unit,
a data output,
a projector,
an ambient lighting unit; and
a projection surface on the dashboard,
wherein the evaluation unit is configured to,
ascertain using the data input, information to be displayed; and
using the data output, to project a light pattern representing the information onto the projection surface by way of the projector, or to output the light pattern representing the information by means of an ambient lighting unit.

27. A device for a means of transportation having a dashboard, comprising:
an evaluation unit;
a light source;
wherein the evaluation unit is configured to,
ascertain information to be displayed, and
to cause the light source to provide a light pattern representing the information onto a projection surface on the dashboard;
wherein the light source is at least one of the group consisting of: a projector; and an ambient lighting unit.

28. The device as claimed in claim 27, wherein the device further comprises a fitting protruding from the dashboard, and wherein the projector is arranged on a rear of the fitting.

29. The device as claimed in claim 28, wherein the information to be displayed is generated using a continuous input device, wherein the input device comprises at least one of the group consisting of a slider of the means of transportation and a rotary control of the means of transportation.

30. The device as claimed in claim 27, wherein a spatial extension or a focal point of the light pattern representing the information represents the position of the input means.

31. A means of transportation comprising a device as claimed in claim 27.
